(19) United States
(12) Patent Application Publication
(10) Pub. No.: US 2018/0334055 A1
(43) Pub. Date: Nov. 22, 2018

(54) ALTERNATING SEAT SETTING

(71) Applicant: Ford Global Technologies, LLC, Dearborn, MI (US)

(72) Inventors: Nikica Hennes, Aachen (DE); Jeroen Lem, Maastricht (NL); Philipp Wolf, Cologne (DE)

(73) Assignee: Ford Global Technologies, LLC, Dearborn, MI (US)

(21) Appl. No.: 15/949,523

(22) Filed: Apr. 10, 2018

(30) Foreign Application Priority Data
May 18, 2017 (DE) 102017208388.3

(51) Int. Cl. B60N 2/02; B60N 2/06; B60N 2/16; B60N 2/22; B60N 2/10

(52) U.S. Cl. CPC B60N 2/0244; B60N 2/06; B60N 2002/0268; B60N 2/22; B60N 2/10; B60N 2/16

(57) ABSTRACT

A method is provided for controlling a vehicle seat, wherein settings of parts of the vehicle seat are dynamically adjusted depending on person-related parameters of the person seated on the seat, to make the seated position of the person as favorable as possible under biomechanical aspects.

### FIELD OF THE INVENTION

The present invention generally relates to vehicle seat control, and more particularly relates to a method for dynamically changing settings of parts of a vehicle seat depending on person-related parameters.

### BACKGROUND OF THE INVENTION

Static sitting in a vehicle seat over a longer period of time can be uncomfortable and unhealthy. One possibility for avoiding static sitting in vehicle seats is automatically alternating between multiple different seat settings. The pattern of such an alternation can be set, for example, with respect to seat positions, frequency of the changes, speed of the moving seat parts, and time intervals between the changes as disclosed in DE 102014214849 A1, or with respect to driving conditions or location of the corresponding vehicle as disclosed in U.S. Pat. No. 9,187,020 B2.

The values of the changed parameters are conventionally based on data which are ascertained in studies. For example, it can be ascertained that the highest acceptable deviation from a preset position of the backrest is 1°, the angle amplitude by which the position of the backrest can be changed is also only 1°. In this case, the change of the angle amplitude is equal for all users. However, a very large person can have different requirements with respect to the angle amplitude of the backrest position or a seating surface position than a small person. Furthermore, requirements with respect to a posture can also change during travel of the vehicle. It would be desirable to provide for individual and dynamic setting changes of vehicle seat parts.

### SUMMARY OF THE INVENTION

According to one aspect of the invention, a method for controlling a vehicle seat with a control unit is provided. The method includes the steps of ascertaining at least one first person-related parameter of a person seated on the vehicle seat, acquiring present seat setting parameters settable by the person, and ascertaining adaptations by which settings of settable parts of the vehicle seat can be changed depending on the ascertained first parameter. The method also includes the steps of setting the settings upon starting operation of the vehicle, and dynamically changing the settings depending on the ascertained first parameter during the operation of the vehicle.

According to another aspect of the present invention, a method for controlling a vehicle seat is provided. The method includes the steps of ascertaining a first parameter of a person seated on the vehicle seat, acquiring present seat setting parameters settable by the person, setting settings of settable parts of the vehicle seat upon starting operation of the vehicle, and dynamically changing the settings depending on the ascertained first parameter.

According to a further aspect of the present invention, a system for controlling a vehicle seat. The system for controlling a vehicle seat includes a control unit. The control unit is configured to ascertain a first parameter of a person seated on the vehicle seat, acquire present seat setting parameters, ascertain settings of settable parts of the vehicle seat, set settings of the settable parts upon starting operation of the vehicle, and dynamically change the settings depending on the ascertained first parameter during the operation of the vehicle.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a schematic side illustration of a vehicle seat, according to one embodiment;

FIG. 2 is a schematic side illustration of a seated person while the method according to the embodiment is carried out; and

FIG. 3 is a flow chart of a method for controlling the vehicle seat, according to one embodiment.

### DETAILED DESCRIPTION OF THE PREFERRED EMBODIMENTS

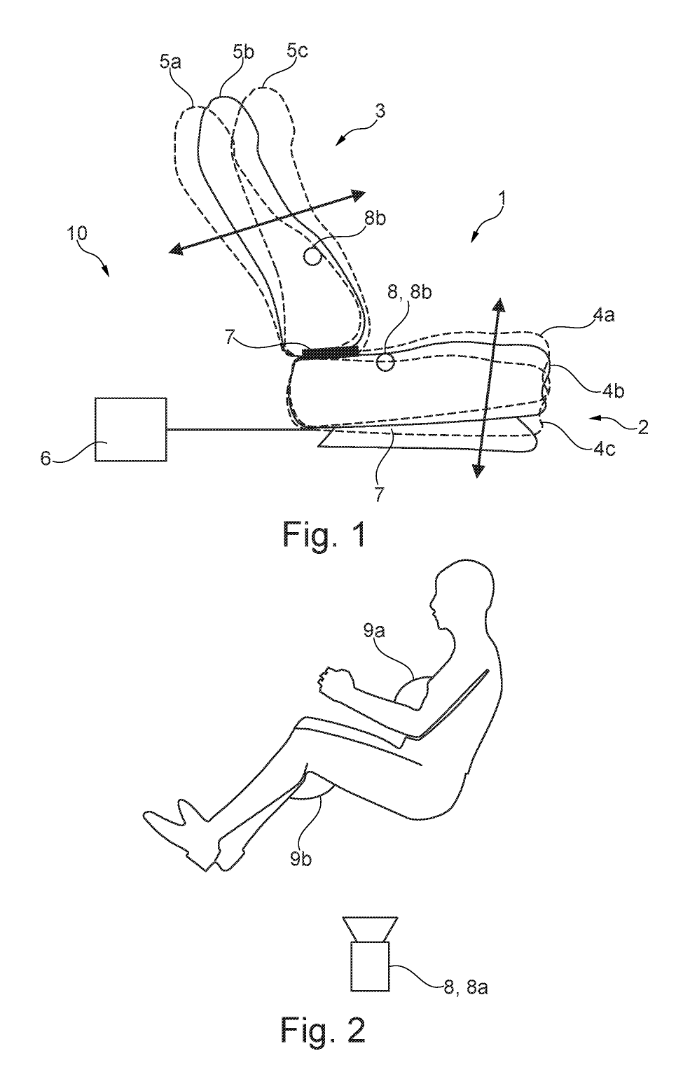

FIG. 1 shows a system 10 for controlling a vehicle seat 1. In one embodiment, the seat 1 is a seat of a motor vehicle, such as a passenger car, van, truck, SUV, etc., but could alternatively, for example, also be a seat of an aircraft or of a ship. The seat has a seat surface 2 and a backrest 3. The seat surface 2 can be adjusted into various positions 4a, 4b, and 4c according to the illustration of FIG. 1. The backrest 3 can be adjusted into various positions 5a, 5b, and 5c at various inclination angles according to the illustration of FIG. 1. The illustrated positions are by way of example. The number of the illustrated angles is by way of example, just two or a larger number of angles can also be set. In this case, the angles can be set in predefined steps, but preferably continuously is one embodiment. The illustration of setting options of parts of the seat 1 is performed here on the basis of the seat surface 2 and the backrest 3, likewise by way of example. The seat 1 additionally comprises further parts, which can be set differently.

The seat 1 has respectively at least one actuator unit 7 activatable by a control unit 6, which is provided for alternating the angles of the seat surface 2 and the backrest 3. Furthermore, the seat 1 has at least one actuator unit 7, which is designed for displacing the seat 1 in the longitudinal direction of the vehicle forward or backward or for adjusting the height of the seat 1. The actuator units 7 may function, for example, on an electrical or hydraulic basis or may include other actuators.

The control unit 6 is connected to an input unit, via which at least one first person-related parameter (related to the person seated on the seat 1) can be input and transmitted to the control unit 6. The first person-related parameters can be input manually via the input unit. The first person-related parameters include, for example, body size, weight, and seat height of the person. Parameters can be input manually via the input unit, for example via a keyboard or a touchscreen, and also via a spoken instructions.

Furthermore, the control unit 6 is connected to sensors 8, which are arranged in the vehicle. The sensors 8 may include, for example, a camera 8a, which is arranged in the vehicle interior, or a capacitive sensor 8b, which is integrated in the seat 1. The camera 8a captures and records images of the body of the person seated on the seat 1.

According to FIG. 2, the camera 8a is designed and provided to record specific angles of the body, particularly of the knee joint 9a and the elbow joint 9b. The ascertained angles and other sensor values are referred to as second person-related parameters, which relate in particular to the posture of the person seated on the seat 1. In addition to the camera 8a, for example, other sensors such as capacitive sensors may also be used to determine the posture of the person seated on the seat via recorded pressure values.

The control unit 6 is designed to ascertain and evaluate a posture of the person from the transmitted sensor values and to transmit control commands to the actuator units 7. The actuator units 7 adjust the angle of the seat surface 2 or the angle of the backrest 3 or both.

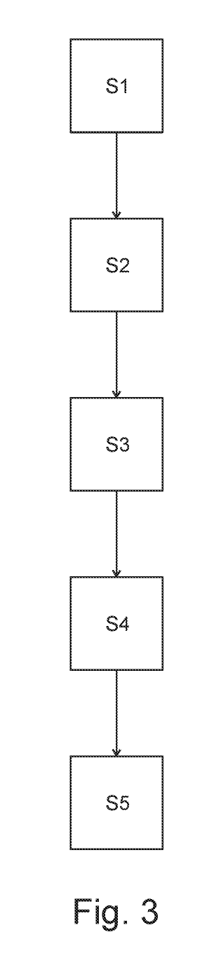

In one embodiment of the method as shown in the illustration of FIG. 3, in a first step S1, the size, the weight, and the seat height of a person seated on the vehicle seat 1 are input by the person via the input device as first person-related parameters. In one embodiment, the person inputs the data manually via a keyboard of the input device. However, the first person-related parameters may be input by voice commands or other inputs. The data are transmitted to and processed by the control unit 6.

In a second step S2, present seat setting parameters settable by the person himself are acquired. In the specific embodiment, this relates, for example, to the angle of inclination of the seat surface 2 and the angle of inclination of the backrest 3.

In a third step S3, an angle of inclination is ascertained, by which the position of the backrest 3 and/or of the seat surface 2 can be changed depending on the ascertained first parameter. In this case, the respective angle of inclination is directed to enabling the most ergonomic sitting possible for the person depending on the first parameters.

In a fourth step S4, a starting angle of inclination of the backrest 3 and/or of the seat surface 2 is set by the seated person. The forward movement of the motor vehicle is then started.

In a fifth step S5, the angle of inclination of the backrest 3 and/or of the seat surface 2 is dynamically changed depending on the ascertained first parameters to facilitate the seat position of the seated person. For this purpose, the control unit 6 ascertains from the ascertained data whether the posture of the seated person is uncomfortable or cramped. An angle of inclination of seat surface 2 and/or angle of inclination of the backrest 3 is then ascertained, which enables a more comfortable seated position. For this purpose, in addition to the angles of inclination, the longitudinally directed position and/or the seat height of the seat 1 can be adjusted.

In one embodiment of the method, the seat position of the driver or of a person seated on a seat other than the driver's seat is monitored during the travel of the motor vehicle by the sensors 8, which continuously transmit second person-related parameters of the person seated on the vehicle seat to the control unit 6, particularly present angles which are recorded by the camera 8a or multiple cameras 8a, of the knee joints 9a or of the elbow joints 9b.

In a further embodiment of the method, in step S5, the transmission of control commands for actuating the actuator units 7 can be performed depending on the posture additionally at specific intervals. Furthermore, a movement pattern of the person can be ascertained by the control unit 6 from the sensor values in step S4. The movement pattern is incorporated into a change pattern for the dynamic change of the angles of inclination of seat surface 2 and backrest 3 and also further position changes of the seat 1.

A first aspect of the disclosure relates to a method for controlling a vehicle seat by use of a system, which comprises at least the vehicle seat and a control unit. The method includes ascertaining at least one first person-related parameter of a person seated on the vehicle seat, acquiring the present seat setting parameters settable by the person, ascertaining adaptations by which the settings of settable parts of the vehicle seat can be changed depending on the ascertained first parameter, setting starting settings of the settable parts of the vehicle seat upon starting the operation of the vehicle, and dynamically changing the settings depending on the ascertained first parameter during the operation of the vehicle.

The method according to the disclosure is advantageous because it enables a dynamic setting of a vehicle seat depending on anthropometric, particularly biomechanical, data of a person seated on the seat. An individually adapted seat setting and a corresponding dynamic change pattern can thus be set on the basis of biomechanical parameters.

A vehicle is understood herein as any arbitrary land, air, or water vehicle. The method according to the disclosure may be carried out using an electrically settable seat in a vehicle, particularly using the seat of the person who is driving, but can also be carried out using any other seat in the vehicle.

In the method according to the disclosure, the first parameter is preferably selected from the group comprising one or more of the body size, body angle, limb length, shoulder width, hip width, weight, seat height, and other anthropometric or biomechanical parameters of the seated person. These anthropometric data are advantageously used to compute a dynamic change pattern of the seat settings. Seat setting parameters relate to all settings which are related to the vehicle seat, for example, the seat height, angles of inclination of seat surface and backrest, and the distance of the seat from the front boundary of the vehicle interior.

Furthermore, the first parameter is preferably input manually via a vehicle-connected system. For this purpose, for example, a touchscreen in the region of the vehicle dashboard or a mobile telephone can be used. The data can also be input via a specific key or voice command, which is linked to a specific profile, which is already stored in the vehicle or is transmitted.

In addition to the manual input, specific anthropometric data, for example body weight or body size, can also be sensed or ascertained in a sensor-based manner and transmitted to the control unit for use with the method. It is therefore preferable in some embodiments if the system additionally comprises at least one sensor. An automatic acquisition of the first person-related parameter is thus enabled, which is transmitted to the control unit, so that settings of the vehicle seat can advantageously be set automatically. The sensor can be used in this case as the sole data source in the method, so that no anthropometric data are manually input. The manual input and the acquisition of anthropometric data by the sensor can also be combined with one another.

The system preferably comprises at least one camera. The camera is used to acquire a body position, particularly body angles, for example, of the knee joints and/or the elbow joints. The camera is arranged in the interior of the vehicle and is a type of sensor. The camera, as explained above for the sensor, can be used as the sole data source for the acquisition of the first person-related parameter in the method, so that no anthropometric data are manually input, according to one embodiment. The manual input and the acquisition of anthropometric data by the camera can also be combined with one another.

Preferably, in the method according to the disclosure, at least one second person-related parameter of the person seated on the vehicle seat is sensed or otherwise ascertained. The second person-related parameter is used for dynamically ascertaining a change pattern of the seat settings. The second parameter is preferably selected from the group comprising the angle of at least one body joint and the position of at least one body part. The angles may relate, for example, to the knee joint, hip joint, shoulder joint, and elbow joint. In this case, the second parameter is preferably ascertained in a sensor-based manner. For this purpose, at least one sensor is used, which is arranged so that it can acquire specific angles. The sensor can be, for example, the camera in the interior of the vehicle, which is already used for ascertaining the first parameter, or a further camera, or else for example a capacitive sensor, which is installed in the vehicle seat. Of course, multiple different sensors can be used. On the basis of the ascertained angles, an optimum change pattern of the seat setting can be dynamically recomputed and set during the vehicle travel, while the angles of body joints and therefore the posture change. The second parameter can also be used in the method in conjunction with the anthropometric data of the first parameter, to prepare a dynamic change pattern at the beginning of the method.

Preferably, in the method according to the disclosure, the frequency of the dynamic change of the settings is also set depending on the ascertained parameters. In this case, the most advantageous interval for a specific driver or passenger between changes of the seat setting is set in accordance with the ascertained parameters.

The setting of specific settings depending on the ascertained parameters may be limited by limits, according to one embodiment. This embodiment is particularly advantageous for the driver's seat, because especially the backrest may not be adjusted by an angle of inclination which makes it difficult for the driver to reach the steering wheel even with outstretched arms.

Furthermore, in the method, the control unit may be connected to at least one smart device associated with the person, according to one embodiment. Smart devices are understood, for example, as fitness trackers, smart watches, and smart phones, particularly having synchronized calendars. In this case, the change pattern of the seat setting can advantageously be adapted to the activity which the person seated on the seat has previously practiced (for example sport, meetings, longer seated activity) or intends to practice. In this case, the change pattern can also be used in the sense of a warm-up or warm-down function with respect to sporting activities in a further embodiment of the method, or in a stimulating manner on unused body parts.

Furthermore, it is preferable if, in the method, the movement pattern of the person is ascertained and the dynamic change of the settings is adapted to the movement pattern. A camera may ideally be used in this case to ascertain the movement pattern. Movement patterns are advantageously established in this case which are associated with an uncomfortable feeling, and the change pattern of the seat setting is adapted accordingly.

The camera can also be used to establish whether a change of the seat setting has provided the desired effect. Furthermore, for example in autonomous vehicles, the person seated on the seat can be observed and, in the event of longer periods of inactivity, a specific change pattern of the seat setting can be achieved.

The settable parts of the vehicle seat preferably comprise at least the seat surface and the backrest. The parts of the vehicle seat directly linked to the person are thus advantageously dynamically set in particular. Vehicle seats conventionally have a seat surface and a backrest. The term seat surface is used here for the part of the seat on which a person sits, even if this thus actually means more than just the actual upper surface. The backrest is the part of the seat on which the person leans with their back in the seated position.

Another aspect of the disclosure relates to a vehicle having a vehicle seat, which comprises a backrest, a seat surface, a control unit, and at least one sensor and is designed to execute the method according to the disclosure.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method for controlling a vehicle seat with a control unit, comprising:
ascertaining at least one first person-related parameter of a person seated on the vehicle seat;
acquiring present seat setting parameters settable by the person;
ascertaining adaptations by which settings of settable parts of the vehicle seat can be changed depending on the ascertained first parameter;
setting the settings upon starting operation of the vehicle; and
dynamically changing the settings depending on the ascertained first parameter during the operation of the vehicle.

2. The method as claimed in claim 1, wherein the at least one first parameter comprises one or more anthropometric or biomechanical parameters of the person.

3. The method as claimed in claim 1, wherein the at least one first parameter comprises one or more of body size, body angle, limb length, shoulder width, hip width, weight, and seat height, of the person.

4. The method as claimed in claim 1 further comprising the step of processing at least one signal from at least one sensor.

5. The method as claimed in claim 1 further comprising the step of processing at least one image from at least one camera.

6. The method as claimed in claim 1 further comprising the step of ascertaining at least one second person-related parameter of the person seated on the vehicle seat.

7. The method as claimed in claim 6, wherein the second parameter comprises at least one of an angle of at least one body joint and a position of at least one body part.

8. The method as claimed in claim 7, wherein the second parameter is ascertained in a sensor-based manner.

9. The method as claimed in claim 1, wherein frequency of the dynamic change of the settings is also set depending on the ascertained parameters.

10. The method as claimed in claim 1, wherein the setting of specific settings depending on the ascertained parameters is limited by safety limits.

11. The method as claimed in claim 1, wherein the control unit is connected to at least one smart device associated with the person.

12. The method as claimed in claim 1, wherein a movement pattern of the person is ascertained and the dynamic change of the settings is adapted to the movement pattern.

13. The method as claimed in claim 1, wherein the settable parts of the vehicle seat comprise at least a seat surface and a backrest.

14. A method for controlling a vehicle seat, comprising:
ascertaining a first parameter of a person seated on the vehicle seat;
acquiring present seat setting parameters settable by the person;
setting settings of settable parts of the vehicle seat upon starting operation of the vehicle; and
dynamically changing the settings depending on the ascertained first parameter.

15. The method as claimed in claim 14, wherein the first parameter comprises one or more of body size, body angle, limb length, shoulder width, hip width, weight, and seat height, of the person.

16. The method as claimed in claim 14 further comprising the step of ascertaining a second parameter of the person seated on the vehicle seat, wherein the second parameter comprises one or more of an angle of at least one body joint and a position of at least one body part.

17. The method of claim 14 further comprising ascertaining adaptations by which the settings of settable parts of the vehicle seat can be changed depending on the ascertained first parameter.

18. A system for controlling a vehicle seat, comprising:
a control unit configured to:
ascertain a first parameter of a person seated on the vehicle seat;
acquire present seat setting parameters;
ascertain settings of settable parts of the vehicle seat;
set settings of the settable parts upon starting operation of the vehicle; and
dynamically change the settings depending on the ascertained first parameter during the operation of the vehicle.

19. The system as claimed in claim 18, wherein the at least one first parameter comprises one or more of body size, body angle, limb length, shoulder width, hip width, weight, and seat height, of the person.

20. The system as claimed in claim 18 further comprising the step of ascertaining at least one second person-related parameter of the person seated on the vehicle seat, wherein the second parameter comprises one or more of an angle of at least one body joint and a position of at least one body part.
